(19) United States
(12) Patent Application Publication
(10) Pub. No.: US 2010/0036926 A1
(43) Pub. Date: Feb. 11, 2010

(54) PLATFORM AND METHOD FOR CROSS-CHANNEL COMMUNICATION

(76) Inventors: Matthew Lawrence Ahart, Los Angeles, CA (US); James Maxwell Whiting, Glendale, CA (US)

Correspondence Address: MATTHEW L. AHART, Esq., 3413 Alginet Drive, Encino, CA, 91436, US

(21) Appl. No.: 12/538,372

(22) Filed: Aug. 10, 2009

Related U.S. Application Data
(60) Provisional application No. 61/087,462, filed on Aug. 8, 2008.

(51) Int. Cl. G06F 15/16

(52) U.S. Cl. 709/206

(57) ABSTRACT

The present invention relates to the provision of a trans-communication hub. The hub allows users who use different communication mechanisms to cross-connect, thus facilitating communication. This invention will be especially valuable for intergenerational communication where different levels of technological capability are involved.

### CROSS-REFERENCE TO RELATED APPLICATIONS

This non-provisional patent application claims priority to Provisional U.S. Patent Application No. 61/087,462 filed Aug. 8, 2008 entitled “Platform and Method for Cross-Channel Communication.” The contents of this provisional application are fully incorporated herein by reference.

### FIELD OF THE INVENTION

The present invention relates to telecommunication merging traditional telephone networks and more modern communication means including e-mail, fax and text messaging. Specifically, the present invention relates to the establishment of a system for criss-crossing communications between postal mail, electronic mail (e-mail), fax, internet telephony, instant messaging and electronic chat. The invention can also extend to other forms, such as forums, blogs, and social networking sites. Electronic messages (email, fax, instant messages, electronic chat, broadcast messages, blog content, comments on profiles, etc.) can all be converted into non-electronic format using the invention, also.

### FEDERALLY SPONSORED RESEARCH

Not applicable.

### SEQUENCE LISTING OR PROGRAM

Not applicable.

### BACKGROUND OF THE INVENTION

The standards of communication have evolved rapidly over the past twenty years. Previously, communication was centered around standard POTS (plain old telephone system) and postal mail. However, with the advent of e-mail, communication has been steadily moving away from postal mail. And, recently as internet telephony has expanded, POTS has become less and less important. Internet telephony now dominates long-distance calling and is increasingly starting to impinge on local calling (the so-called “last mile”).

As communication means have developed, younger generations have adopted newer communication techniques. Today's youth use e-mail, instant messaging, text messaging, and broadcast messaging. Broadcast messaging refers to communication techniques such as blogging, leaving comments on a profile or “wall” (e.g., MySpace or Facebook), group chat (such as that using a socket server, etc.).

Some people, however, have been slow or unable to adopt newer communication techniques. As a result, there is a growing communications disconnect between those who have not adopted newer communication techniques and those who have. This disconnect hinders communication. One such example of this disconnect is between the young and the old, such as between a grandparent and a grandchild. Another example involves the blind or hearing impaired whose ability to use certain communication mediums is limited.

It is desirable to overcome or diminish this disconnect to allow family members and friends to communicate effectively. Recently, companies have begun to address the disconnect. However, these companies either are not useful for the technologically challenged or they do not facilitate two-way communication.

Presto and MyCelery are communication companies that require the use of a fax machine. Each allows elderly individuals access to e-mail using fax technology as a means of converting e-mail into printed matter. E-mail directed to a senior citizen is terminated at a fax machine at the elderly individual's residence and the fax machine prints the fax out. While these systems do convert a more-modern communication technique (email) into a more traditional communication form (printed text), these systems suffer from the disadvantage that a fax machine is required. Since elderly individuals may not desire to have an additional piece of electrical equipment in their home, this limits the desirability of such a system.

A phone-to-email system is disclosed in US 2005/0010573A1 of Garg. However, Garg's system is not useful for the blind or elderly because it only allows use of the telephone and email. Many senior citizens dislike using the telephone and do not have access to email.

Many companies that address aspects of the problem do not allow two-way communication. This is true in the email-mail space. Companies such as Postful and PostaGram connect email with a postal mailbox. For example, PostaGram is a company that advertises itself as accepting email which is then printed and mailed to a postal address. However, PostaGram's service is expensive because each email is separately mailed. In addition, PostaGram's service does not allow a recipient of a printed email to reply using the system. Postful's service is similar, each email is separately printed and mailed to a mailing address. Neither company's service allows a recipient to write a response which is then delivered by email; and neither company's service collects multiple messages and sends a group of messages at once.

There are companies that allow their customers to electronify their postal mail. For example, using Earth Class Mail, a customer can have all her postal mail scanned and uploaded and made available for reading on the worldwide web. Mail Scan Pro scans postal mail and sends the customer an email. These companies, however, do not intend to facilitate two-way communication, but rather focus on allowing postal mail to be accessible over the web.

It is desired to create a communication system that allows two-way communication across different communication means that is cost-effective and usable by the elderly and/or disabled.

### SUMMARY OF THE INVENTION

The present invention is directed to a communication hub that allows for improved communication across communication mechanisms (email, phone, text message, postal mail, instant message, broadcast message, fax). A cross-mechanism system that allows each person to use his/her preferred mechanism will allow the communication divide to be overcome.

The invention can utilize the increasingly efficient and cost-effective technology of the internet and internet telephony to create an affordable and efficient cross-mechanism system. In addition, modern social media networking systems such as Facebook, LinkedIn, and Twitter can be integrated into the system.

It is important to note that all communication mechanisms for transmitting messages can be used as means to receive messages. For example, the phone-to-postal mail combination could work to allow a caller to send messages that are delivered via postal mail and similarly to allow a caller to receive messages that were mailed by postal mail and converted into a telephone call.

### BRIEF DESCRIPTION OF THE DRAWINGS

FIG. 1 illustrates the general hub concept. Communication can come in via any communication mechanism and it may be delivered by any other communication mechanism.

FIGS. 2, 3, 4a and 4b illustrates one communication in one embodiment of the invention whereby a tech-savvy user sends and receives messages by email and telephone and a tech-challenged user sends and receives messages by postal mail and telephone.

FIG. 5 illustrates how the phone call-in system works in an embodiment of the invention that allows a caller to both record messages and listen to messages.

FIGS. 6a, 6b, and 6c illustrate the combination of telephone, postal mail, and phone mechanisms in one embodiment of the invention.

FIG. 7 shows a digest mid-way through processing.

FIG. 8 shows the call flow for an embodiment allowing a user to call and record a message.

FIG. 9 shows a response form in an embodiment where written messages are electronified for delivery.

FIG. 10 outlines the processing of response forms.

### DETAILED DESCRIPTION OF PREFERRED EMBODIMENTS

The present invention combines many existing technologies to build a new cross-mechanism communication system. Technologies that are incorporated include email and fax, voice-over-internet-protocol (VOIP), phone keypad input, servers, database, scripting, scanning and OMR/OCR/ICR, text-to-speech, speech-to-text and text-to-speech, and databases.

### Email and Fax

Email and fax are existing technologies that allow communication. Email can be authored using an email “client” application (like Outlook) that downloads messages to a user's “client” console (e.g., computer), or they can be authored using webmail applications (such as Hotmail) or still other means. Fax allows for the delivery of written information using the telephone system.

### VOIP

Voice-over-internet-protocol is an existing technology whereby voice communication is routed across the internet. This technology allows for the cheap transfer of telephone and fax information. In addition, any location with an IP address becomes capable of receiving telephone and fax messages very cheaply.

### Server

Where the invention incorporates a telephone connection, one aspect of the invention is the connection between the voice system and a PBX. Although much voice traffic (phone calls) is currently carried over the internet, and this share is steadily increasing, the present invention contemplates connecting voice information with internet information. For example, when an incoming email is sent, the incoming email may be saved in storage. If the email's content is destined as an outgoing message that will be sent across a telephone network, then the email must be connected to a telephone network.

It is well-known in the telephony art that a phone call can be terminated at a location that is accessible by the internet. In one example, a phone number can be associated with an IP address using DDI (DID). This connection can be made via SIP or IAX. The inventor has experimented with a connection using an account from IPKall.

Once a phone number is routed to an IP address, there must be something at that IP address that knows how to answer a phone and deal with the phone. Proprietary software exists that can be used for this. In addition, Asterisk can be used.

The above description describes a system whereby phone calls are terminated to a system using IP telephony. It is also possible to use a phone system that is linked to a server using a card. For example, a voice T1 line can be connected to a server using a Digium card. The inventor has also successfully implemented such a system. This server does not have to be on the internet to answer incoming calls, although it is desirable to link it to the internet to allow it to perform other functions such as: (1) sending calls out from the system, (2) reading and writing to an external database, (3) accessing external websites such as news sites or other sites of interest for informational content, (4) sending faxes and emails, (5) submitting payment information and receiving response information to payment gateways.

The server that runs the PBX application (e.g., Asterisk/FreePBX) can be a traditional web server, such as one that runs Apache. The server should have enough memory to store sound files, if they are used, as well as be fast enough to handle many users at once.

PBX applications are designed to handle multiple users at once. Where this is the case, the telephone connection must be established to allow multiple callers to call-in to the system at once.

### Scripts

Scripts can also be used to process information, such as incoming messages. These scripts can arrange for storage of incoming messages, processing of messages, and to arrange output. For example, in one embodiment, email messages may be stored in a MySQL database. A script then would write the incoming message into the database, possibly also processing the message. For example, a MySQL database may have a table for containing incoming messages. This table may have the following fields: recipient, sender, date sent, subject, body text, attachment1, attachment2, attachment3. A script may read the incoming email, process the email into its parts and put the relevant information into each field in a database. In this embodiment, a single entry (row) in a table would correspond to a single message. It is readily understood, however, that other database designs may be employed.

The script may process email as it arrives, after it is placed in temporary storage, or only as needed. In one aspect of the invention, communications may be sent at set times. For example, there could be a weekly phone call whereby incoming messages are read to a user. If the phone call occurs at a pre-set time, then messages that arrive earlier will be queued until the pre-appointed time. A CRON job can be scheduled that will ensure that the call occurs at the appointed time.

Scripts can be written in any of many different languages. The user has experience with Perl and php, although C++ may be preferable for image-handling capability, such as OMR.

### Scanning and OMR/OCR/ICR

One form of input is the written message. The written message can be hand-written or type-written. It may be necessary to transition a written message to other forms of communication using scanning and optical mark recognition (OMR), optical character recognition (OCR), or intelligent character recognition (ICR). Scanners exist that can quickly and easily scan and allow the scanned material to be processed on a computer or, if desired, to upload the scanned document to a network or other locations where they can be processed by a script.

For example, if a written letter is to be terminated as an email, as may be desired if an elderly user writes a letter and wants it to be terminated at an email of a younger recipient, the written letter will have to be converted into a digital format suitable for electronic communication. Such an electronic format could involve a simple scan into a .TIFF or .JPEG or .GIF or .PDF file, or it could also involve OCR/OMR/ICR.

There is a tradeoff involving speed, cost, accuracy, bandwidth and formatting that will determine the choice between scanning alone and the use of OMR, OCR, or ICR. A scanned image file requires less scanning resource, and is a more precise representation of the original input written message. However, a scanned image consumes more memory (and thus bandwidth in transition), and may be in a format that is less-suitable for termination. For example, if the ultimate termination destination is a “wall” on Facebook, an image is not nearly as suitable as a text comment. In addition, information that can be gleaned applying OMR-OCR-ICR technology may be needed to automate the operation of the hub. For example, a barcode or string of characters may identify the identity of a sender. Similarly, other information may identify the identity of a recipient. By applying OMR, OCR, or ICR, this information may be obtained and the system can transmit messages using less human intervention. OMR, OCR, and ICR can be applied in several places in varying embodiments, including on a scanner with processing ability, on a computer connected to the scanner, on a computer remote from the scanner, or on a server running software. In addition, a proof-checking tool could be used to verify the accuracy of OMR, OCR and ICR.

OMR can be useful. For example, if a user mails a filled out response form to the system, the response form may include a bar code that contains user information. OMR can read the bar code to determine the identity of the user. Similarly, OMR can be used to read user input. For example, if a user selects from a list of potential recipients of his/her message, the selection may be made by filling in a bubble or ticking a checkbox. This selection can be determined using OMR.

Similarly, OCR can be used. If a user's identity is contained in characters contained on the written message, OCR can be used to determine that identity. For example, in one embodiment, a response form is used that prints the name of the sender atop the form and also includes a numeric code for the user at the bottom of the form. OCR can be used to read the name that is printed at the top of the form and to read the numeric code at the bottom of the form. By comparing either the name or code (or both) with information in a database, the identity of the sender can be determined. In an analogous manner, OCR can be used to determine the identity of a message recipient. Finally, OCR can also be used to identify message text. This message text could then be used more easily in other communication mechanisms. Examples include converting the written message to a phone call using text-to-speech and a calling system, sending the message as a text message, or sending the message in a nicely formatted email. In one embodiment, where digests are mailed, a response form could be sent with every digest or a form could be sent only when one was needed, and the number of response forms could be tracked by the system. In addition, response forms could be mailed with business reply envelopes.

Using ICR, a handwritten input can be converted into text for the body of a text e-mail. A scanned image may be better sent as an attachment to an email or embedded in an email.

Where incoming written (by hand or typed) text is involved, scanning will occur at a physical facility using scanning equipment. The scanning equipment may also provide OMR, OCR or ICR using software on the scanner or a nearby computer. If OCR is not done at the scanning location, it can be done on a different computer, or it can be done on the server. One of skill in the art is familiar with many potential applications that can be used for OMR/OCR/ICR, including ABBYY Recognition Server 2.0, Adlib Express Recognition Server, Aspire OCR, GOCR/JOCR, IRISPdf Server, Ocrad, Ocropus, Tesseract, ABBYY FineReader 9.0, Scan2Text, SimpleOCR, AccuSoft ImageGear for .NET, Cardiff Teleform, PC OMR, OMR-AI, Remark Office OMR. Because some of these applications work on desktops, others on servers, and others are code samples that can be incorporated in a proprietary application, care will be given to selecting an application that works well in the overall hub system. For example, a phone and scanning system can use Asterisk (which is Linux-based) and then a PC attached to a scanner where the PC runs Windows and uses SimpleOCR.

### Text-to-Speech and Speech-to-Text

A server will likely contain a text-to-speech application. An application like Cepstral can be installed easily to perform this function. Text-to-speech can be used to convert a written message into a sound message. For example, an email that is to be terminated by calling a user's telephone may be converted into speech. In addition, text-to-speech is useful for a senior user who is calling into the system. If the user desires to leave a message, text-to-speech could read a series of names of potential recipients of the message and the user could select which user is the intended recipient(s).

It may also be desirable to convert spoken language to text. Voice recognition software is available to accomplish this. At the present time, voice recognition software is best suited for applications involving limited universes of potential voice responses (e.g., determining whether the user said “yes” or “no”), although it can be used to transcribe voice messages, which can then be transmitted in other media.

Using less automation, speech can be converted to text using human transcription. Human transcription is more reliable that existing voice recognition software although it entails additional cost. A combination of human transcription (or quality checking) with voice recognition applications may also be used.

### Database

A database can be used to store client information. The database can be housed on the server that performs the phone-answering, or it can be remote. A remote database may be housed on a remote server. For a remote database, it is possible to enable remote access by means of an approved userid and password and to allow the IP address of the remote user access. Also, because the volume of information stored may be substantial, it may be desirable to use dedicated storage (hard drives). A database can be used to note locations of stored information.

Although the inventor is most familiar with MySQL, any type of database can be used. A database can be queried using scripts. For example, Perl and php scripts easily submit queries to a database to insert, update, modify, drop, add, alter, select and perform other functions.

The system will employ a database or other structure capable of defining the associations needed to practice the invention. In addition to billing information and address information, there will have to be associations between message senders and message receivers.

### Accounts

It is possible that an account can be established. In one embodiment of the invention an account is centered on a senior user. The senior user will then have a list of authorized senders. These authorized senders can send messages that will then be passed along to the senior user. Messages addressed to the senior user that are not originated by the authorized user will not be passed along. This feature allows for strong spam-blocking. In this approach, payment and login information need not be established in the name of, or by, the senior user. In fact, it is envisioned that where the invention is used for grandchild-to-grandparent communication, that the account may bill and be setup by a grandchild or parent/child.

In another embodiment, the account can be centered around a technically-capable user, who has email and is likely to send email which is printed and provided to recipients. It is readily understood that the invention is not limited to who signs up for the account or who pays for the account.

### Incoming: Written Messages

Written messages may be submitted to the system. In one embodiment of the invention it is envisioned that an elderly user may respond to messages received by writing a handwritten response. Such a response may later be converted into an electronified form for delivery, such as email, text message or broadcast message.

In this instance, scanning and OMR-OCR-ICR may be used, as discussed previously. A template may be used to facilitate this process. Templates can be provided to a user along with other printed messages, to facilitate communication. For example, in an embodiment where emails are delivered via digest, the digest may be mailed to the elderly user accompanied with one or more postcards. A digest may be sent every day, every week, every two weeks, every month, or on special occasions (like Mother's Day, Father's Day, Grandparent's Day, Christmas, birthdays). The postcard will have pre-printed information in pre-set locations on the card that identify the user and potential recipients. Or, the recipient name or code can be printed and it can be identified using OCR or OMR. The user may merely place a check or X next to potential recipients and thus the OCR or scan of the postcard can focus especially on this part of the card to determine a potential recipient.

In one embodiment, the addressing information is OCR-ed and the rest of the message is scanned as an image and communicated as an image file. In this manner, the system can identify the recipient of a postcard from an elderly person with reliability and low cost; and at the same time, the message will be transmitted with complete accuracy because no information will be corrupted or degraded by OCR.

As discussed, a postcard can be used. However, a printed sheet of paper or a coupon may be used. A postcard may be postage prepaid, or a separate envelope may be provided for submission of paper and the envelope may be prepaid. In one embodiment, when a digest of emails is mailed to an elderly person, the mail packet will include a response form that contains identifying information on the sender and potential recipients of the message, and a postage prepaid envelope may also be provided.

Incoming mail can be treated similarly to the way a lockbox is used in the financial services industry. A lockbox is typically a post office box where payments from customers are sent. Payment information (usually a coupon) is submitted along with a form of payment, such as a check. The lockbox is located at a banking institution and the banking institution opens the mail, scans the coupon and the check.

### Incoming: E-Mail

E-mails may be sent into the system. These emails likely will be sent by tech-savvy individuals. Emails may be processed before being sent further. Header information may be read to determine the recipient and also the sender. Furthermore, established preferences or information contained within the e-mail may determine how the e-mail is sent on. For example, a recipient may have a preference for how to receive messages for a specific sender. E-mails into the system are reviewed to determine if the sender is approved to send messages to the recipient. If the sender is not approved, the sender may be notified that (s)he is not approved and (s)he can seek approval. In one embodiment, if the sender is approved, delivery preferences may be consulted in the database to determine how to deliver the message.

For example, if email into the system is delivered in a digest form, a thumbnail picture of the sender or a caricature of the sender may be associated with the incoming message when it is printed in the digest. This makes the digest more personal.

In addition, filtering may be necessary to filter out inappropriate or undesirable content such as email forwards, spam, pornography/obscenity, lengthy signature blocks (as are attached to many law firm emails), or advertisements that are attached by email providers.

In addition to this processing, other formatting may be done. For example, multiple messages from a given sender may be sorted and put together. This way, if there is a weekly or monthly digest, the digest may include all messages from sender A and then all messages from sender B, etc. Also, email may be in HTML or Text format. HTML email may be processed by extracting the text from the page using known programming methods. For example, Email Sentinel Pro is an application that does this conversion. Also, emails may contain embedded messages, if it is a forward or reply. The embedded message can be removed, if desired. One such method, for example, is to recognize the beginning of the embedded message, which can be done by looking for indications such as “- - - - - -Original Message- - - - - -”, “To:”, “Message from”, etc. Different mail sending programs have different indications.

In addition, there may be an image handling processor. This processor may convert images to a format that is more suitable for printing. This may involve deskewing, cropping, resizing, re-coloring, converting to black-and-white or gray-scale, etc. Images may be processed to meet aesthetic requirements. For example, if an emailer sends many images, the images may be resized so as not to take up excessive space and printing resource. However, if an emailer sends only one image, that image may be shown at a larger size, 3″×4″ or 2″×3″ are considered desirable, depending on the shape of the image. An image can also be rotated for better presentation.

It should also be noted that messages coming into the system in the form of “e-mail” may be sent both as an email to the system or they can be entered into the system using a web-mail application. In addition, an email may be sent containing a sound file. Such a file may be handled similarly to a recorded phone call. Also, messages coming into the system as “e-mail” can also be submitted from social networking sites, such as Facebook. For example, a Facebook application could allow Facebook users to send messages to the system from inside Facebook. Such an application could open (or could prompt the user to open) when a user uploads a photo or posts an update, or on a user's decision to open the application. iPhone and BlackBerry and other mobile devices can similarly be integrated into the system.

Incoming email may be processed by installing an email application on the server, and utilizing processing software in the application. Alternatively, customized software programs—e.g., in Java, C, Perl—can be employed to process incoming email. In one embodiment, incoming emails will be monitored. For example, if an email comes in and contains an attachment that is in a non-compliant format, the system will want to notify the sender that the attachment is non-compliant to ask the sender to send a compliant attachment format. A case of this would be sending an image file in a format that the system cannot read (such as a proprietary format, like PhotoShop), and the system would request an image file in a standardized, supported format (such as GIF, TIFF, JPEG, PCX, PNG, BMP). Persons of the art will recognize that this email monitoring could be done in at least two ways. First, all emails, as they arrive, could be monitored. A “sniffing” program, like MailSnarf, could be used to do this. Alternatively, a CRON job could be used on the email inbox that periodically looks at emails. The CRON job could remove emails that have been analyzed out of the inbox (so that they are not re-scanned in subsequent runs of the CRON job). The removed email information could be saved in a database or saved in a different folder in the email application (or simply not marked as “new” any more, if the monitoring program only reviews “new” messages).

In one embodiment of the invention, a sender sends email to the hub; the hub processes the email and prints the email, and sends the printed email to the receiver. The receiver can reply in writing, and the written response can be uploaded into email format. It is possible that the sender can send email to an easily remembered email address, such as grandma@ . . . use the sender is known to the hub, sender information (e.g., “From:” field) can be used to look in a database or other data storage, to determine who grandma@ . . . is. As long as each sender has only one “grandma”, multiple senders can each send messages to grandma@ . . . . And each message will be forwarded to the correct recipient. Although this has been described using email as the sending mechanism, the concept can be extended to other sending mechanisms. For example, a text message or phone call can be made to a number where many senders use the same phone number, but because of the recognition of the sender, the recipient is correctly identified.

### Incoming: Phone

Another method into the system is via telephone. Such a call may be via a POTS connection or voice over internet protocol (VOIP).

A call into the system can be recorded and then processed as a sound file (.wav, most likely). This recording can be automated and thus no customer service resource consumed answering telephones and taking messages.

On a call into the system the caller may input information (as discussed below) to identify him/herself. This identifying information may include a string of key inputs or spoken information that is processed using voice recognition.

Caller-id may also be used because a caller calling from a known phone number may be more quickly identified. For example, an elderly user of the system may have three grandchildren that are known recipients of messages. If the elderly user calls from a known phone number, the system may immediately recognize the caller, without the caller entering any information, and the system can immediately ask the caller which grandchild is the intended recipient of the message about to be spoken. Text-to-speech and recorded sound files will be used to facilitate this information gathering process. It is also possible that data gathered from multiple sources such as webform may be used.

The sound file that is recorded can be transcribed or the sound file can itself be used. If transcribed, the transcription can be transmitted in any manner that written text can be handled (e.g., text message, email, printing and mailing, etc.). If the sound file is used, the sound file can attached to an email, be saved as a voice message which can be accessed by logging into the system either over the web (and then downloading the file or streaming it) or via telephone.

To facilitate communication between a caller and a system, there must be a mechanism whereby input is taken from the caller. Input can be received from a caller using either voice recognition or input via a phone keypad (DTMF INPUT). This is also sometimes referred to as Touch-Tone® input. A user can enter numerical information by pressing numerical keys on his/her phone handset. When each key is pressed a tone corresponding to that key is transmitted. A receiver will hear the tone and translate it into the number that is entered (or a code designating that number).

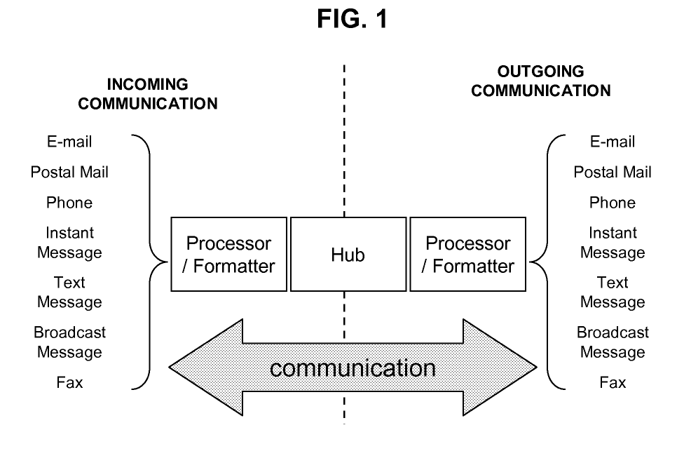

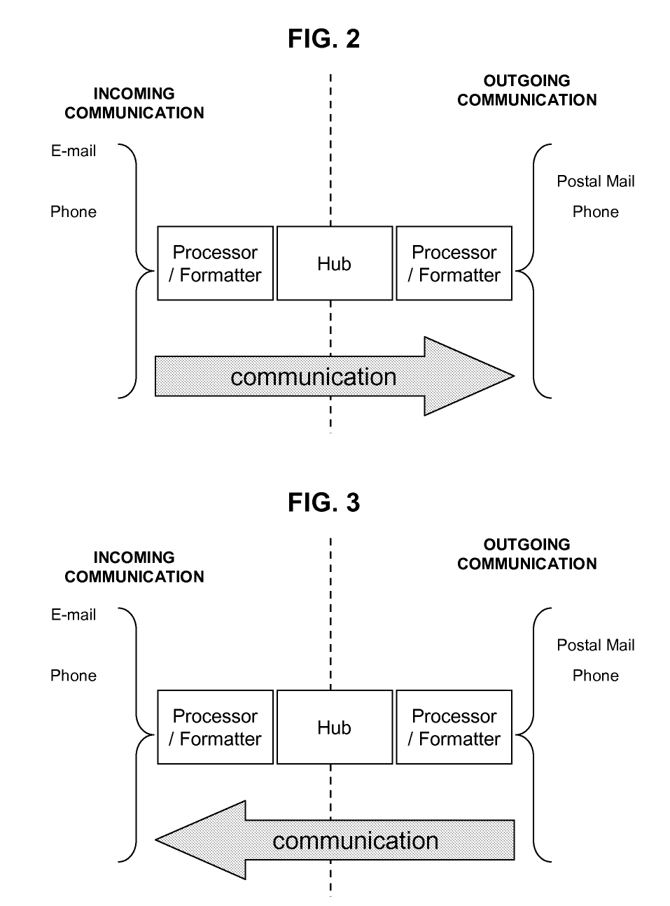

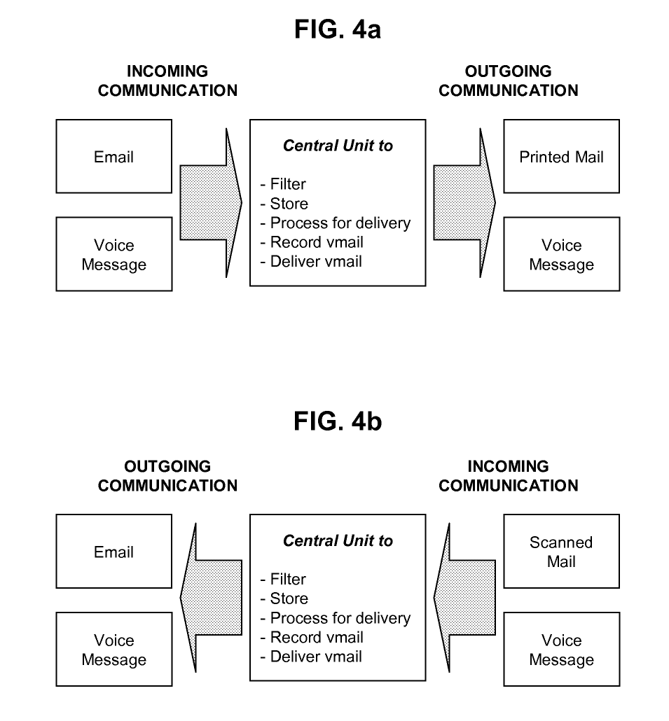

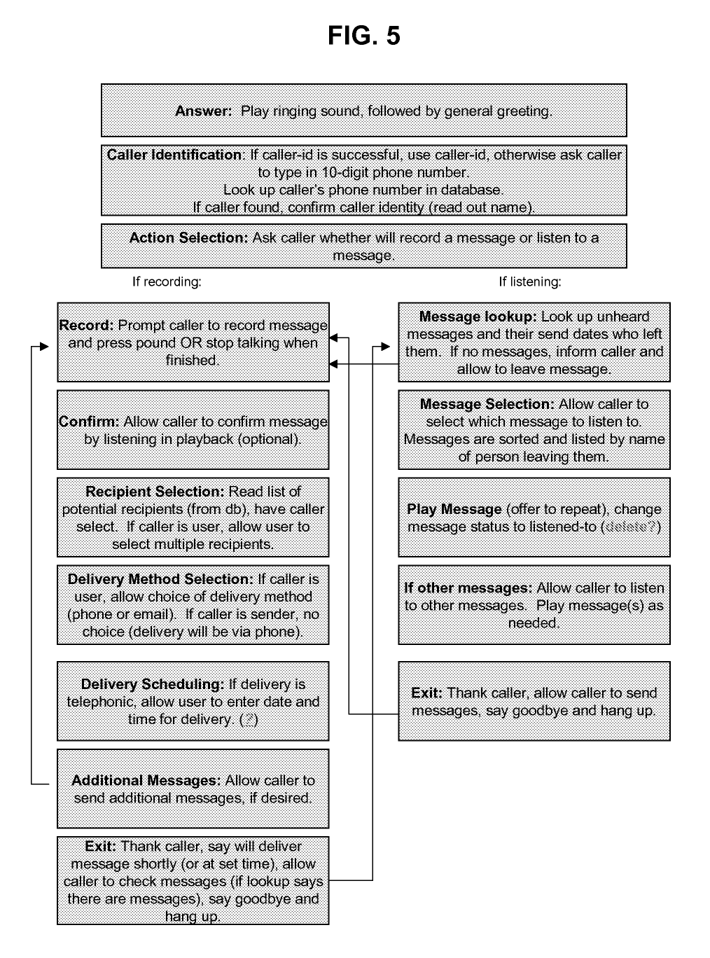

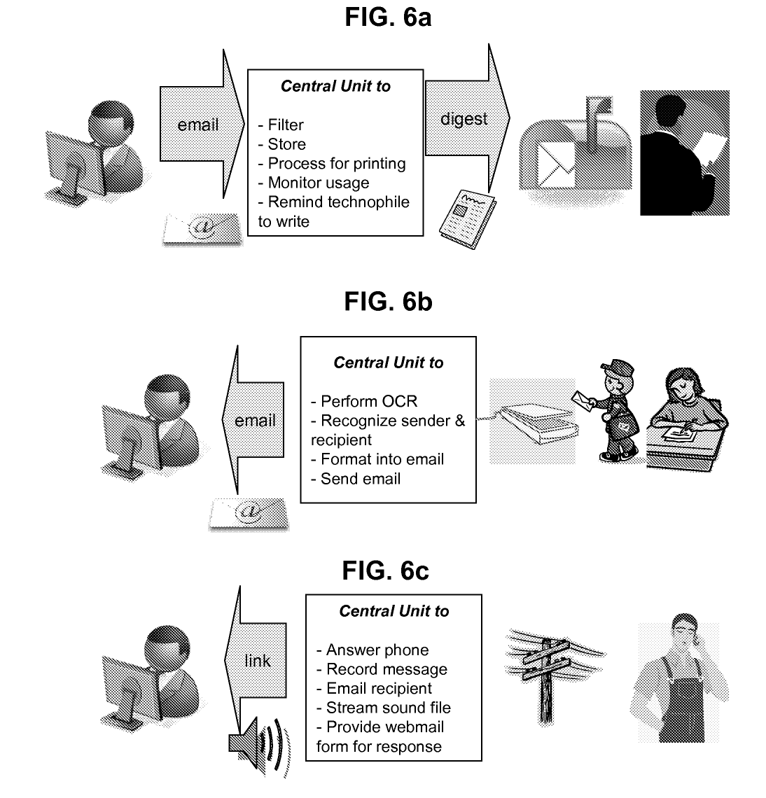

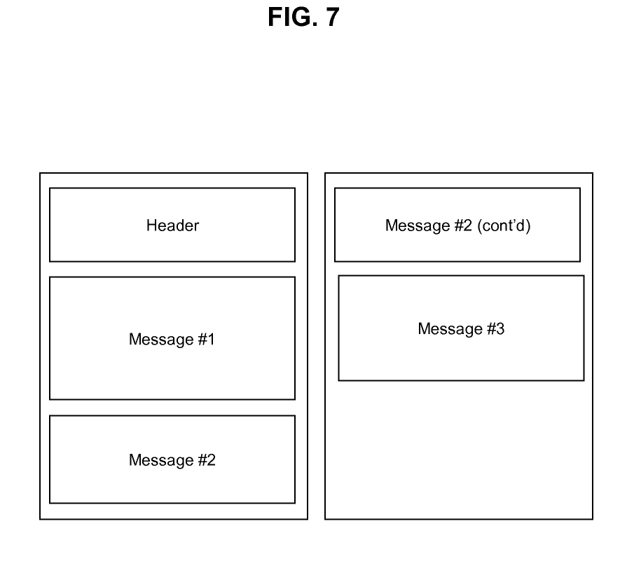

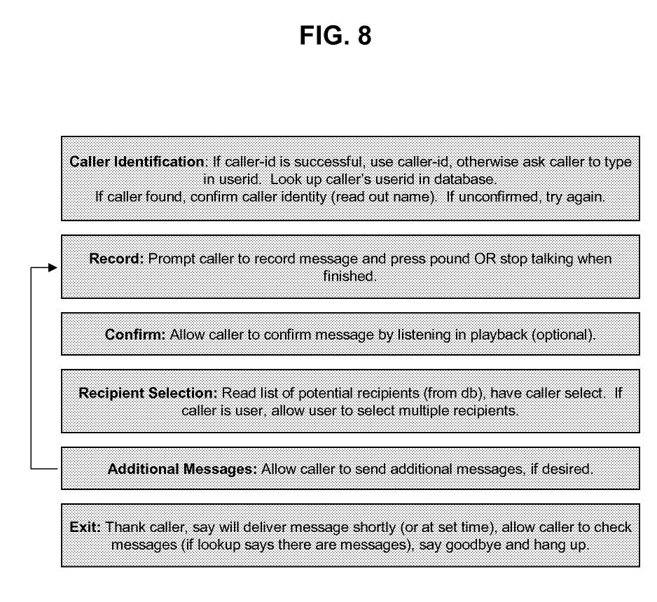

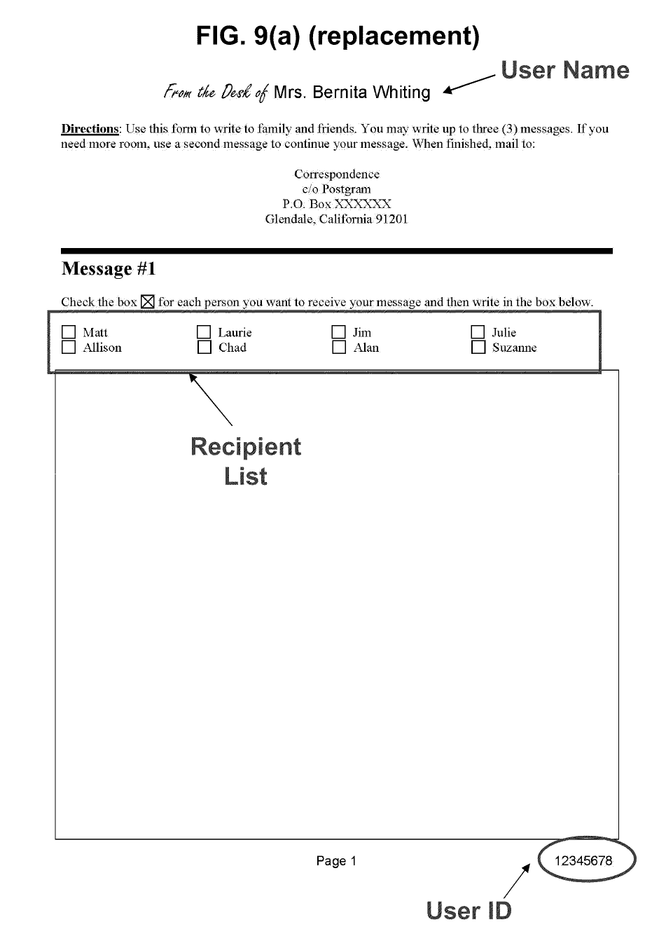

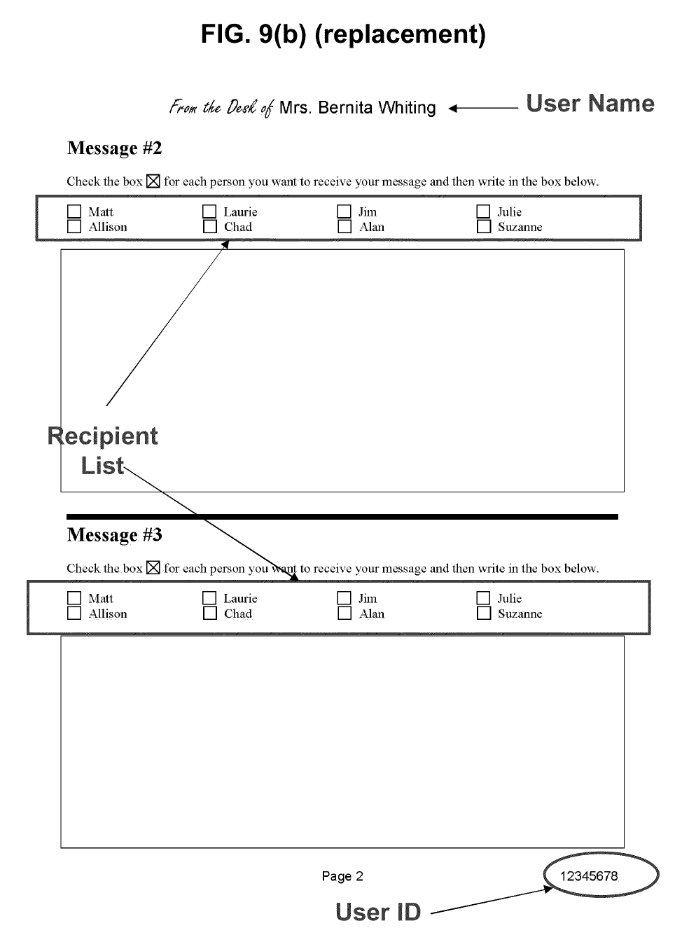

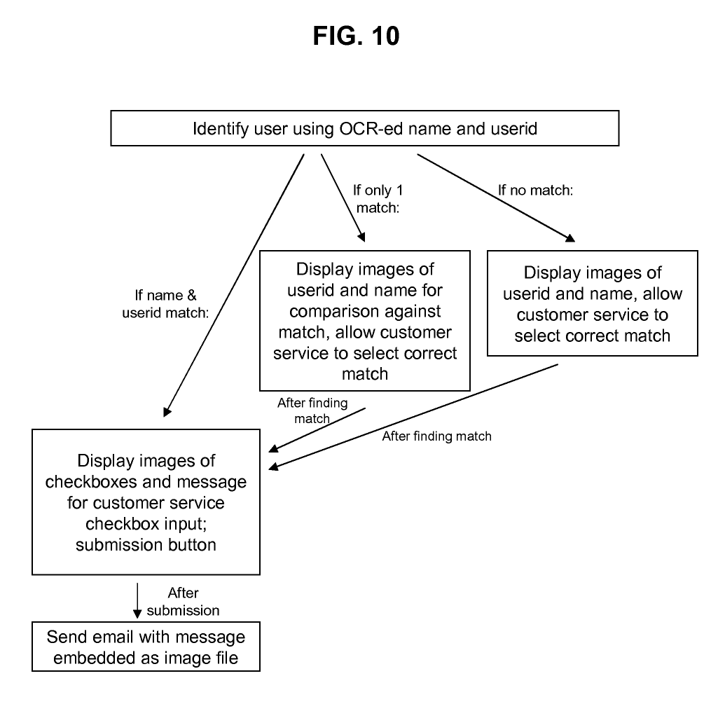

In addition, the keypad can also be used to transmit alphabetical (letter) information. This can be done by mapping the numbers on the keypad to the letters of the alphabet. One such example that is commonly understood is shown in FIG. 1.

Text-messaging techniques can be used. In one method, it is commonly understood when text-messaging that a user may rotate among the letters associated with a key. For example, pressing the “2” key once corresponds to “a”, pressing twice corresponds to “b”, and pressing three times corresponds to “c”.

In another method, called T9word, a user will spell a word by pressing the keys corresponding to each letter and a program running dictionary algorithms will attempt to find the matching word. For example, a user could enter “223” which corresponds to any word spelled with a first letter of “a”, “b”, or “c”, a second letter of “a”, “b”, or “c”, and a third letter of “d”, “e, “f”. A list of words with letters matching the “223” code can be maintained in a database, along with the frequencies of their use.

Different matching algorithms can be utilized. The user could be prompted with the most commonly used word matching “223”, and the user can accept or reject. The accept/reject decision can be made by pressing a key (e.g., “*” to accept, and “#” to reject). If the most common word is rejected, then the next most common word may be suggested. For example, “223” corresponds to the following words “bad”, “ace”, “cad”, in order of their frequency. If bad is the most common word, then it would be suggested. If the user rejects “bad”, then “ace” would be suggested. If “ace” is rejected, then “cad” is suggested. Alternatively, the list of known words could be maintained and the words could be offered in alphabetical order. In this case, “ace” would be offered first, “bad” second, and “cad” last.

It is also possible to match by using a partial match. In this instance, “223” could correspond to any of the three-letter words discussed, or it could correspond to the first three letters of a word with more than three letters (such as “baffle”). A dictionary translating words to starting letter key-sequences could be used. This approach is less attractive where letters can correspond to any word, but this approach is effective when a limited known list of words is used. Such an example would be to specify a state of the United States. For example, a user seeking to enter “New Jersey” as his/her state could enter “639” for the first three letters and then the list of states starting with “639” could be used as suggestions. In this manner, the New Jersey user would not have to spell his/her entire state.

Another way to identify location information is to use numerical ZIP codes. For example, a user could enter a 5-digit ZIP code, and a lookup function could use this 5-digit ZIP code to identify the state of the user.

In addition to DTMF input, voice recognition can be used. Voice recognition software can be used to determine what a user has input. At present, voice recognition software works best where user input is restricted to a limited universe of possible answers (e.g., “yes” or “no”).

The phone portion of the system can be illustrated in a schematic of trees and menus. These trees can be established in a variety of ways. The inventor created a partial replica of this course using a dialplan in Asterisk and using a variety of extensions and “Goto” techniques. Freeware that sits atop Asterisk, like FreePBX can also be used. In addition, proprietary software can be written that performs this function—such software may sit atop Asterisk or FreePBX, or it may be its own solution that is not based on either Asterisk or FreePBX. Such a system can be installed on a server, either a Linux or Unix or Microsoft server.

### Incoming: Text Message

Another form of incoming message is the text message. A text message can be treated similarly to an email or a phone call. A text message contains identifying information similar to caller-id.

### Incoming: Broadcast Message

A broadcast message is any message that can be submitted using non-traditional means such as blogging, commenting on a profile (such as MySpace or a Facebook wall), or a chat application running on a socket server. A broadcast message contains information about the sender as well as digital message information which can be easily handled.

### Incoming: Fax

A fax can be handled similarly to an input image file. Thus, it is similar to a written message. The fax can be OCR-ed and thus processed. In addition, the sender information (like caller-id) can be used to facilitate processing.

### Incoming: Other

It is to be understood that any method of receiving incoming communication can work with this invention. For example, a person could submit an audio file, possibly by recording on his/her computer or other device. This submission could be made via email, uploading, or any other method of passing into the hub. In addition, a person could call into the hub and the hub could record his/her phone call. This recording could quite easily be passed along, possibly as an email attachment (or part of a body in a more-advanced email format), or it could be transcribed and passed along (e.g., by text message, email, or printing).

### Outgoing: E-Mail

Messages going out of the system may be delivered by email. It is envisioned that a message from an elderly sender may be converted for delivery as email. Or delivered as a text message, blog entry, broadcast message, wiki. Such an outgoing email can be in text format or HTML format, and may contain attachments. For example, if a voice message is transcribed, the transcription may be in the “body” of an email, but the voice message may also be attached as a sound file. An outgoing email should identify the sender and may also identify the name of the communication service.

The “Reply-To” and/or “From” fields of the email may be set up so that a recipient of the email can hit “reply” and the correct address will be presented so that the reply, once received by the system, will route to the correct person. For example, a written message that is scanned and emailed from a user who is associated with the email address “grandma601@postgram.com” should be set up so that on reply the message is sent to “grandma601@postgram.com”.

The email can also be formatted for better presentation. For example, the communication service can attach its logo to the email or present the email in HTML format using a logo and other features. Similarly, links can be included in the email to allow the receiver of the email to log in to the communication service, change preferences, receive other messages, and review correspondence history. All outgoing emails can be either HTML or Text format, a recipient may express a preference which the system will honor.

Sending email for pickup using a link or sending a notification that a voice message is available for pickup, also, is advantageous because it compels the user to visit the website and thus facilitates an immediate response (e.g., by putting a response window below the message).

### Outgoing: Written Messages

Messages to elderly users may be delivered in any manner, but it is anticipated that written form may be most desirable. Written messages can be delivered via the postal mail. If messages are to be delivered by the postal mail, their content will have to be printed, stapled (optional), folded (optional) and stuffed into an envelope. Printing can be done on any size paper, with 8.5″×11″ a standard format, and 17″×11″ one alternative that will allow for folded-over presentation (like a book, each 17″×11″ sheet can create four sides of reading content). There are existing machines for printing, stapling, folding and stuffing that can be used to automate the process.

One option is to print on 8.5″×11″ (standard letter) paper and then fold in half to fit into an envelope of approximately 6″×9″ size. This size envelope can be easily (and cheaply) handled by the U.S. Post Office. Furthermore, if a window is used on the envelope, envelopes will not need variable content, which will reduce the cost of printing envelopes.

A novel and exciting option is to deliver multiple messages at the same time in a digest format. This makes the delivery of messages more economical using printing and the mail system because multiple messages can be delivered simultaneously. Furthermore, such a digest can be printed and sent out at regular intervals so that the recipient can plan and anticipate delivery at the same time each week/month, which makes the communication more exciting. If a digest is used, a digest can be formatted to optimize the balance between presentation and printing cost. For example, if a digest contains color images, color images could be collected onto pages so that the maximum number of pages would contain single-color content. Because many printing companies charge “per click” (if any color is on a page the entire page is charged as a color print page), this will reduce printing costs. Another option is to re-size images to fit pages and to manage the use of ink/toner. For example, images are generally quite well-viewed in 3″×4″ size or 3″×5″ size, so images of a larger size may be re-sized for printing. In addition, if this resizing is done appropriately, it can reduce memory/resource needs by converting an image into a smaller version. Another formatting option is to format around page breaks and fold creases. By placing an entire message on the same page, readability is increased. Line spacing, font-size and margins can all be adjusted to vary digest size and spacing. Advertising and white space can be placed to consume space.

In addition to digest, individual messages can be delivered in a letter or postcard manner. It is envisioned that special messages may be sent as a “shooter.” A shooter is a message that is immediately processed and sent to the end-user. A message can be designated as special either in the preferences in the system (for example, all messages from one sender may be special and shot), or the sender may designate a message as special. Such a designation may be contained anywhere in the submission. For an email, the special designation may be in the body, subject, “to” field or any other field. Shooters could also be sent after an entry on a webform.

A written message may contain information in addition to the messages from senders. For example, the messages could be merged with news content, webpage content, RSS feeds, blogs or content in subject areas of interest to the sender or recipient. This would make the entire package more interesting and facilitate communication of information beyond that authored by senders. In addition, written messages may also contain advertising. Such advertising may be tailored to known demographic profile of a recipient.

Outgoing messages should be in a font and format that is easily read. For sight-impaired, large-font or Braille printing may be used. Additionally, outgoing messages, both audio and text can be translated into another language.

In one embodiment of the invention, a message is sent by mail and the recipient is able to respond using postal mail as well. In this embodiment, response forms can be mailed with a message to allow the recipient to respond on a standardized form. Use of a standardized form will allow for easy processing and information on the standardized form such as a barcode, a string of alphanumeric characters or a name can be printed to identify the recipient. This way when a recipient's response is returned to the system, the response can be handled using automated OMR/OCR/ICR processes. If response forms are used, business reply envelopes may also be used. Business reply envelopes can be included with message mailings (along with response forms, if desired). This will allow the recipient of a message to reply without purchasing stamps and/or paper. If response forms and envelopes are used, also, the supply of these materials with a recipient can be monitored in a database. When a recipient sends a message in, the system will recognize that a response form (or more than one) has been used, as has an envelope. When the recipient runs low on response forms and/or envelopes, additional forms and/or envelopes can be mailed to him. In the embodiment where a recipient can receive and reply by mail, this will allow for sending forms and/or envelopes when needed, and not with every message or digest. In this embodiment, a recipient can also request additional response forms and/or envelopes by calling customer service. If a digest is used, the frequency of mailing messages can be managed in regard to response form and/or envelope needs and postage. For example, a digest could be mailed sooner than would otherwise be the case if a response form or envelope is included, this will shorten the digest, but will allow a response form and/or envelope to be included in a digest mailing without incurring additional stamp charges. Or, a response form and reply envelope could be mailed only when one or both of them could be inserted in an envelope without incurring additional postage cost. In an embodiment where messages are mailed, the system could process and prepare messages in batches for printing. These batches could group digests by the number of pages (for each user), to make printing, folding, stuffing and mailing easier.

### Outgoing: Telephone

Another method of terminating a message is via the telephone. For example, an email can be converted to speech using a text-to-speech application and then the system can call the message recipient using an outgoing SIP port. In this embodiment, when the recipient is called, an introduction identifying the message source may be presented before beginning the message. Such a message may include identification that the message is from the system, and then that the message is from a given sender, and then the sender's message may be presented.

Alternatively, the message can be contained in the system and the recipient can call into the system to listen to the message. In this instance a message can be relayed to the recipient informing him/her that he/she has a message waiting. If such a call-in is used, the call-in would preferably employ a toll-free number and caller-id and other coding is desired to facilitate the call-in function. When a user receives such a message, (s)he may be notified by email, text message or other mechanism that the message is available.

In addition, voice imitation can be used. Voice imitation involves mimicking the voice of the sender. In its simplest form a message sender is associated with a stored voice that sounds similar to the sender's voice. In a more complex form, the message sender could record sounds and these sounds can be used to interpolate a sound using text-to-speech technology.

In an automated system, output sent to the caller can be done via sound files. .wav or .mp3 are choices, although .wav is preferred because it is a format that works well for spoken content. In addition, there are known text-to-voice tools that can create sound output from data input. For example, “SAY” commands in Asterisk can be used to generate sounds. These text-to-voice tools essentially look up sound files corresponding to the letters or numbers involved and play them.

There are also known tools that pronounce words, rather than single letters. These can be used. One such example is available for demonstration purposes from AT&T research, available at http://www.research.att.com/˜ttsweb/tts/demo.php. Other text-to-speech “readers” include Festival, Flite, Reallspeak, NaturalReader, Acapela, Cepstral, VozMe, CalTrox's Speech Synthesizer, and others. Although these “readers” are not all intended for use on a server-side of an application, they can be customized or tailored.

### Outgoing: Instant Message

A message can also be sent out as an instant message. In one embodiment of the invention, it is anticipated that instant messages may be sent to a more technologically-capable recipient, usually the younger of the sender and receiver. The system may send all messages to the recipient as instant message or only special messages designated for delivery as instant message may be deliver in this manner.

It is anticipated that, because of the rapid communication aspect of an instant message, phone messages may be transcribed for sending as instant message.

### Outgoing: Broadcast Message

An outgoing message may also be transmitted in a broadcast format. Such a message may be posted onto a family blog and notification of the posting may be transmitted. Alternatively, such a message may be posted as a comment, such as on a MySpace profile or Facebook wall.

### Outgoing: Fax

Outgoing messages may also be delivered as a fax.

### Receiving and Sending Platform

In one embodiment, a receiving and sending platform in the user's home would be used to record and store audio messages transmitted via phone line from the hub. The platform would have similar functionality to a standard answering machine, but could record and send outgoing messages that would terminate as emails or other more technologically advanced medium. It also could utilize standard caller ID functionality to differentiate between standard phone calls and calls coming from the HUB. Since calls from the HUB could have their genesis as emails and therefore be sent during off-hours, the platform could immediately answer in order to stop the disrupting ringing of the phone. The platform could also double as a standard digital answering machine.

### PREFERENCES

As mentioned previously, preferences can be established to govern the messaging interaction. These preferences can be established at account setup, by accessing the system using a web portal, calling the system and using a prompt system, or by calling and speaking with a customer service representative, or by traditional mail. Preferences can determine: font size, volume, frequency of message delivery (e.g., in a digest format), the mechanism to use for message delivery or receipt (where multiple mechanisms are provided), the time to deliver/receive (e.g., phone messages should not be delivered in the middle of the night), the frequency or existence of reminders, etc.

Preferences can be established specific to a given sender or they may be specific to a given recipient or for a recipient-sender combination. Preferences may also be set for a given message (e.g., what mechanism to use to deliver a message in a system involving multiple delivery mechanisms for a recipient).

In addition, a web portal can allow for monitoring of the communication status. For example, in communication between a grandparent and grandchildren, a parent can log into the system or call with a phone and discover who has been corresponding with the grandparent and who has not.

Monitoring need not be done via a web portal. For example, if an elderly user is to receive a weekly digest containing messages from her grandchildren, if, after a predetermined number of days no message has been received from one grandchild, a reminder may be transmitted to that grandchild that he should send a message to the grandmother. Such a reminder can be sent in any manner. Similarly, the number of days and frequency of reminders can be adjusted to ensure digests contain sufficient quantity of messages.

Frequency of reminders could be a function of sender patterns—patterns that send messages often would not be reminded, because presumably they did not send a message at some point because they were busy or unavailable, not because they needed to be reminded. In addition, reminders could be focused on users who do not receive a lot of messages—to make sure that they get messages in their digests. Users who already receive a lot of messages would not have reminders sent to their senders because such reminders would not be necessary to generate adequate digest content and they may annoy senders. Reminders should not occur too frequently or they will annoy. In one embodiment involving a digest, a reminder would be sent not more than once a month or not more than every week or two weeks to a sender for a given user, where that sender has not written a message to be included in the digest about to be printed. Reminders can be generated automatically, based off an algorithm that optimizes the frequency of when and identity of who should be reminded. The algorithm may be a function of one or more of: (i) the number or length of messages ready to be sent out to a recipient, (ii) the number of length of messages recently sent out to a recipient, (iii) the number of images ready to be sent out to a recipient, (iv) the number of images recently sent to a recipient, (v) how responsive a sender is to being reminded (based off of past pattern of behavior), (vi) when a sender last wrote, (vii) when a sender was last reminded. Reminders can also be submitted by a person who manages an account, called an account manager or person with invite privileges. These reminders may be submitted by logging in to a web portal, or via an application like a Facebook, iPhone or BlackBerry application.

In addition, individual messages can be treated differently. For example, user Bernita can receive emails that are sent in a fax format if an email is sent to bernita-fax@ . . . , and Bernita can receive emails that are sent in a digest format if an email is sent to bernita-diegst@ . . . .

The use of allowed senders also allowed for customizable email addresses. For example, if mattahar@aol.com is an allowed sender for user Margaret Papp, mattahar@aol.com can send a message to grandma@ . . . . And since mattahar@aol.com has only one grandmother in the system, the system can immediately determine that the message is destined for Margaret Papp.

Another preference that may be governed is the frequency of communication. For example, digests may be weekly or bi-weekly or monthly. Similarly, the speed of transmitting messages may be altered, possibly with a varying fee to reflect changes in costs.

Other preferences that may be adjusted include the font characteristics (including size, font, bold, italicization, color) size of written communication, the sound volume of calls, the voice used in calls.

### Message Processing

It is to be understood that the sample claims illustrate aspects of the invention. In the two-way communication system, wherein the invention allows a sender to pass an incoming message to a recipient and the recipient has the ability to respond to the sender, queuing, filtering, and sorting may all be applied to the responding message(s).

### Blind and Deaf Access

It is believed that the present invention will be particularly valuable to those who are blind or deaf. Blind individuals can set their preferences so that messages are delivered in auditory means, or that messages that are printed are printed in a Braille format.

Deaf individuals can have phonic messages transcribed for reading.

### CONCLUSION

It is to be understood that other embodiments may be utilized and structural and functional changes may be made without departing from the scope of the present invention. The foregoing descriptions of embodiments of the invention have been presented for the purposes of illustration and description. It is not intended to be exhaustive or to limit the invention to the precise forms disclosed. Accordingly, many modifications and variations are possible in light of the above teachings. For example, one simple application of the invention would be to allow persons overseas to send postal messages to their loved ones in a different country. An incoming message (such as email, text message, postal mail sent to an agency address in the overseas country, voice message, voice recording made by calling an access number in the overseas country) can be printed and mailed in the destination country, thus expediting delivery and decreasing the cost of postage.

Internet message, as used in the claims, refers to a message (such as a comment on a blog or “wall”) that is available to more than one entity that can look up the message, but is not otherwise delivered to a destination (such as an email address).

Finally, although most claims, as initially drafted, are drafted as method claims, claims covering analogous subject matter can be drafted on the apparatus—including a server and supporting software and hardware (such as a printer or scanner), where relevant.

The invention claimed is:

1. A method of communication comprising:
receiving an incoming message;
processing said incoming message for transmission;
queuing for delivery;
printing delivered message content; and
mailing said delivered message content to a receiving address.

2. The method of claim 1 further comprising filtering.

3. The method of claim 2 wherein at least one message is received and wherein incoming messages are sorted prior to delivery.

4. The method of claim 3 wherein delivered message contents are mailed on at least one postcard.

5. The method of claim 4 wherein said incoming message arrives as electronic mail (email).

6. The method of claim 5 wherein printing and mailing is conducted near the location of the recipient.

7. The method of claim 5 wherein said incoming message arrives as a fax.

8. The method of claim 5 wherein said incoming message arrives as an internet message.

9. The method of claim 5 wherein said message arrives as a text message.

10. A method for delivering a message comprising:
receiving an incoming message where said incoming message does not arrive as a phone call;
processing said incoming message for delivery;
delivering by telephone call to the recipient; and
wherein at least one incoming message is sorted.

11. The method of claim 10 wherein filtering is employed.

12. The method of claim 11 wherein delivery occurs at a pre-set time.

13. The method of claim 10 wherein the delivery includes a greeting.

14. The method of claim 13 wherein said message is replicated by mimicking the voice of the sender.

15. The method of claim 13 wherein caller-id information is submitted with the call.

16. The method of claim 15 wherein said caller-id information includes the name of the delivery service.

17. The method of claim 14 wherein said caller-id information includes the name of the sender.

18. The method of claim 13 wherein said incoming message is sent by email.

19. The method of claim 13 wherein said incoming message is sent by fax.

20. The method of claim 13 wherein said incoming message is sent by internet message.

21. The method of claim 13 wherein said incoming message is sent by text message.

22. A method for transmitting messages comprising:
receiving at least two incoming message;
queuing messages for delivery; and
wherein said messages are received by email.

23. The method of claim 22 wherein messages are sorted.

24. The method of claim 23 wherein sorting is done by sender information.

25. The method of claim 23 wherein said sorting is done by date information.

26. The method of claim 23 wherein said sorting is done by priority.

27. The method of claim 23 wherein incoming messages are filtered.

28. A method for facilitating communication comprising:
accepting incoming messages;
processing said incoming messages;
queuing said incoming messages;
printing messages for delivery; and
mailing printed material to a delivery address.

29. The method of claim 28 wherein incoming messages arrive as email.

30. The method of claim 29 further comprising:
mailing a response form with the printed material.

31. The method of claim 29 further comprising a response mechanism wherein recipient can respond by writing to the service provider, wherein said service provider processes the written response for return delivery, and transmits the written response for return delivery as email.

32. The method of claim 31 further comprising a second response mechanism wherein recipient can respond telephonically by calling said service provider and where said service provider will deliver the telephonic response to the sender of the incoming message.

33. The method of claim 29 further comprising a response mechanism wherein recipient can respond by writing to the service provider, wherein said service provider processes the written response for return delivery, and transmits the written response for return delivery as email.

34. The method of claim 40 further comprising a response mechanism wherein recipient can respond telephonically by calling said service provider and where said service provider will deliver the telephonic response to the sender of the incoming message.

35. A system for connecting electronic messages into printed content comprising
an apparatus for receiving and storing electronic message content from at least one sender;
an application that processes at least two electronic messages into a single digest;
a printer that prints said digest for delivery to at least one user.

36. The system of claim 35 further comprising a response mechanism including
a scanner for scanning a response form;
wherein said response form contains information indicating the identity of said user authoring said response form, the identity of at least one recipient of the response message, and response message content;
an application that processes said response form for delivery;
an electronic mail delivery service; and
a connection to said electronic mail delivery service.

37. The system of claim 36 further comprising an application that validates the identity of a sender of electronic message content as an authorized sender.

38. The system of claim 37 wherein the electronic mail delivery service creates outgoing electronic mail with response information particular to said user.

39. The system of claim 38 wherein the digest is in large print format.

40. The system of claim 38 wherein the digest is printed in Braille.

41. The system of claim 37 further comprising a phone application whereby a user can leave a voice message and said phone application records a voice message and stores said voice message.

42. The system of claim 41 further comprising an email application that sends an email notification that notifies a sender of the voice message after said voice message is recorded.

43. The system of claim 42 wherein said email notification includes a web link to pick up said voice message.

44. A communication system comprising
an apparatus for receiving and storing electronic message content from at least one sender;
an application that processes at least two electronic messages into a single digest;
a printer that prints said digest for delivery to at least one user;
a scanner for scanning a response form;
wherein said response form contains information indicating the identity of said user authoring said response form, the identity of at least one recipient of the response message, and response message content;
an application that processes said response form for electronic mail delivery;
an electronic mail delivery service;
a connection to said electronic mail delivery service;
a phone application whereby said user can leave a user's voice message and said phone application records said user's voice message and stores said user's voice message; and
a phone application whereby a sender can leave a sender's voice message and said phone application records said sender's voice message and stores said sender's voice message.

45. The system of claim 44 further comprising an application that validates the identity of a sender of electronic message content as an authorized sender.

46. The system of claim 45 wherein said digest is printed in large print.

47. The system of claim 45 wherein said digest is printed in Braille.

48. The system of claim 46 further comprising an email application that sends an email notification that notifies a sender that a message is available after said voice message is recorded.

49. The system of claim 46 further comprising a phone application that delivers said user's voice message telephonically.

50. The system of claim 49 further comprising an application to determine how to deliver an incoming message (telephonically or by email/postal mail).
